(19) United States
(12) Patent Application Publication
(10) Pub. No.: US 2002/0145610 A1
(43) Pub. Date: Oct. 10, 2002

(54) Video processing engine overlay filter scaler

(76) Inventors: Steve Barilovits, Charolotte, NC (US); Harry Wise, Orlando, FL (US); Jeffery Dirk Barnett, Port Orange, FL (US); Mitchell Golner, Palo Alto, CA (US); Morgan J. Dempsey, Portland, OR (US)

Correspondence Address: Scully, Scott, Murphy & Presser, 400 Garden City Plaza, Garden City, NY, 11530, US

(21) Appl. No.: 09/978,970

(22) Filed: Oct. 16, 2001

Related U.S. Application Data
(63) Continuation of application No. 09/799,939, filed on Mar. 5, 2001.
Application No. 09/799,939 is a continuation of application No. 09/617,416, filed on Jul. 17, 2000.
(60) Provisional application No. 60/144,288, filed on Jul. 16, 1999.

(51) Int. Cl. G06F 13/00; G06T 1/00; G06F 15/00; G09G 5/39

(52) U.S. Cl. 345/538; 345/501; 345/531

(57) ABSTRACT

The present invention is directed to an Video Processing Engine that is an Overlay Filter Scaler (OFS) having a memory to memory video signal processor decoupled from the display that is better able to meet the feature requirements of a computer graphics system while simplifying the design. The memory-to-memory operation of the video signal processor also facilitates the display of more than one video stream by allowing processed images to be placed in the primary graphics buffers for display. This is particularly useful in video conferencing applications, and for displaying multiple live “thumbnails” of various video feeds. In addition, the signal processor can be used as a graphics anti-aliasing filter by having it process 2-D and 3-D computer graphics images before they are written to the primary display buffer. Similarly, the signal processor can also be used as a “stretch-blitter”, to expand or contract graphics as needed.

### CROSS REFERENCE FOR RELATED APPLICATION

The present application is a continuation application of Ser. No. 09/799,939 filed on Mar. 5, 2001, which is a continuation application of Ser. No. 09/617,416 dated Jul. 17, 2000 which is a conversion of provisional application serial No. 60/1144,288 filed Jul. 16, 1999.

This application is related to U.S. patent application Ser. No. 09/618,082 filed Jul. 17, 2000 and titled Pixel Engine, and is incorporated herewith by reference.

### FIELD OF THE INVENTION

The invention relates to video processing of images for 2D and 3D graphics displays and more particularly to a Overlay Filter Scaler for Scaling, filtering at format conversion in real time for displaying video integrated with 2D and 3D graphics displays.

### BACKGROUND OF THE INVENTION

Video Image Processing Functions

To provide high quality video on a PC, a large set of functions is required for processing individual images——a sequence of which makes up a video stream. Signal processing hardware must be able to scale an incoming image surface with an arbitrary number of horizontal and vertical source pixels to a destination surface with a second arbitrary number of horizontal and vertical pixels. This is necessary to allow the viewing of video in a window that can be resized at will. If only part of each incoming image is to be viewed, the images must be cropped so that only the desired subsidiary rectangular region is processed and displayed. Video streams are transmitted, stored, and decompressed into a variety of video image formats, which must be format converted into a small number of standard formats to minimize the circuit complexity of high speed display drivers. Filtering of images can be performed to enhance or suppress features such as edges in the input images. Picture adjustments provide controls to the user for changing parameters such as brightness, contrast, hue, and saturation. These controls are similar to those for adjusting the picture on a television set. Independent gamma correction for the video image surface separate from gamma controls for the graphics desktop is necessary for full control of the perceived video image quality when it is displayed concurrently with other computer graphics. Special features, such as vertical and horizontal image mirroring are useful for video conferencing and special effects applications. This suite of operations must be performed on every input image at a high enough rate so that all processed images in a video sequence are available for display in real-time. The OFS performs all of these functions.

Digital Image Characteristics and Representations

The primary characteristics of a digital image that must be considered when it is being manipulated include the color space used in representing its pixels, its spatial sampling structure, its temporal sampling structure, and the data structure of the image when it is stored in memory. The variations of these elements leads to many representations of data for the image surfaces used in video storage and processing. A color space is used to represent a gamut of colors, typically as a vector with three numerical components. The spatial sampling structure is the geometric arrangement of points where the components of the image pixels have been sampled during image capture or subsequent image processing. The temporal sampling structure specifies the temporal order in which the pixels of an image were sampled and the image frame rate. Standard image formats have been defined to represent images with a given color space and sampling structure. These elements of video data representation are described in the subsequent sections.

Color Spaces and Gamma Correction

Desktop graphics are typically represented in an RGB (red-green-blue) color space, while YCbCr color spaces are ubiquitous in video transmission and storage systems, and are often used for representing video data on the PC. Both color spaces are based on the tri-stimulus theory of light, wherein three numerical components are necessary and sufficient to reproduce colors visible to the human visual system. RGB is efficient for representing, processing, and displaying computer graphics because it provides a large gamut of colors (e.g. 16.7 million colors with 8 bits representing each of the red, green, and blue components) and the ability for displaying a high-contrast, sharp image for text and graphics. CRT (cathode ray tube) monitors are analog RGB devices, whose electron guns excite red, green, and blue phosphors on a screen to produce light intensity levels that are a function of the voltage applied to the electron guns.

In a linear RGB color space the color component values are proportional to light intensity. Gamma correction is performed on RGB color components to create gamma-corrected non-linear R′G′B′ color space components by use of a non-linear transfer function. The purpose of gamma correction is to compensate for the non-linearity in light intensity as a function of electron gun voltage in a CRT. This non-linearity is primarily due to the physics of the acceleration of electron beams in CRTs, and not to the response of screen phosphors to the intensity of the electron beam.

From the beginning of broadcast television, it has been standard practice to apply gamma correction to video source material, conceptually immediately after capture by a camera, before its transmission or distribution. One of the original motivations for this practice was to eliminate the need for including nonlinear intensity correction circuits in television receivers. Because the intensity response of a CRT is very close to the inverse of the human visual system's perception of brightness as a function of intensity, gamma correction has the added benefit of minimizing the effects of noise on the subjective quality of video. In digital video systems, gamma correction is used to obtain the best perceptual performance when using a limited number of bits to represent color components. Gamma correction is a form of signal companding that adds gain to low intensity values and reduces gain on high intensity values. Broadcast standard gamma correction produces an image that is close to being perceptually linear when viewed on a CRT display.

Almost all CRTs have a gamma of about 2.5, meaning that the intensity of a point on the screen is proportional to the electron gun voltage raised to the 2.5 power. ITU Rec. 709, which defines parameters for HDTV systems, defines the gamma correction function to be applied to each of the linear RGB color components (C) to obtain the gamma-corrected components (C′) as:

$$\begin{matrix}{C}^{′} = 4.5 C , & C \leq 0.018 \\ {C}^{′} = 1.099 {C}^{0.45} - 0.099 , & C > 0.018\end{matrix}$$

In the expressions above, both C and C′ are continuous variables having a range of 0.0 to 1.0.0.0 represents the lowest intensity and 1.0 represents the highest intensity. For both the RGB and R′G′B′ color component systems, a pixel is black if all three color components are 0, and white if all three components are 1.

Human viewers prefer the appearance of video with a slightly increased contrast ratio that is 10% to 20% above that of an accurate reproduction when viewing in a typical living room environment. For this reason, the standard gamma correction exponent is 0.45 rather than the more physically correct value of 0.40 which corresponds to a CRT gamma of 2.5.

The video data streams from almost all video sources, including broadcast television, DVD, VCR, and teleconferencing will have had a gamma correction function applied to them before the data is processed within a PC. For display on a CRT monitor, these video data streams require no further gamma processing. If the display is not a CRT device, such as a an LCD screen or digital micro-mirror device, the inverse of the source gamma correction function followed by the inverse of the display's response function should be applied to the source data before the data is delivered to the display. Two and three dimensional graphics images are computed in a non-gamma corrected linear color space to model the physics of light intensity variation across modeled objects. After the computation of a graphics image is complete, gamma correction should be applied to the image prior to display to compensate for the monitor's non-linear voltage to intensity response.

Thus when computer graphics and video are displayed together on a monitor, separate gamma controls for the video and the graphics surfaces are required to allow both to be displayed with visually accurate color and brightness. In applications like video texture maps, video data is incorporated into graphics images. For these uses of video data, the video's original gamma correction should be inverted before the data is used in graphics processing that manipulates images in a linear color space.

Linear red-green-blue color spaces are denoted by RGB. Gamma corrected red-green-blue color spaces are denoted by R′G′B′. Digital component values in both linear and gamma corrected spaces used in computing devices are represented as unsigned binary numbers, with 0 corresponding to the lowest intensity value, and (2ⁿ⁻1) corresponding the highest intensity value, where n is the number of bits used to represent the color component. Digital television studio equipment often uses R′G′B′ components with a range of 0 to 219.

YCbCr color spaces are derived from gamma corrected R′G′B′ color spaces by a linear transformation. The Y component, called luma, is a weighted sum of the three R′G′B′ components that closely corresponds to the human perception of brightness. Luma is the only component required for the display of a black-and-white image. The other two components, Cb and Cr, are the chroma components, and are proportional to (B′−Y) and (R′−Y), respectively. ITU Rec. 601 specifies the digital representations of Y, Cb, and Cr. Y is an unsigned 8 bit number with 16 representing black and 235 representing white. Cb and Cr are excess-128 coded binary numbers ranging between 16 and 240, with the value 128 representing 0, values between 16 and 127 represent −112 to −1, and values between 129 and 240 represent 1 to 112. (Excess-128 numbers may be converted to the equivalent 2's complement representation by inverting the high order bit). To convert from 8-bit component R′G′B′ (with a code of 0 corresponding to minimum component intensity and a code of 255 corresponding to maximum component intensity) to YCbCr per ITU Rec. 601, the following equations, correct to three decimal places, can be used:

Y=0.257 R′+0.504 G′+0.098 B′+16

Cb=−0.148 R′−0.219 G′+0.439 B′+128

Cr=0.439 R′−0.386 G′−0.071 B′+128

To convert from ITU Rec. 601 YCbCr to 8-bit component R′G′B′ with components ranging from 0 to 255, the following equations can be used:

$$\begin{matrix}{R}^{′} = 1.164 ( Y - 16 ) + 1.596 ( Cr - 128 ) \\ {G}^{′} = 1.164 ( Y - 16 ) - 0.392 ( Cb - 128 ) - 0.813 ( Cr - 128 ) \\ {B}^{′} = 1.164 ( Y - 16 ) + 2.017 ( Cr - 128 )\end{matrix}$$

Slightly different transformations between YCbCr and R′G′B′ color spaces are defined by ITU Rec. 709. Transforming between YCbCr and R′G′B′ spaces can result in out of gamut codes. If the transformation is from R′G′B′ to YCbCr, out of bound components may be clamped to their valid ranges, though the only explicitly prohibited 8-bit values are 0 and 255. If the transformation is from YCbCr to R′G′B′, out of bound components must be clamped to maintain 8-bit representations.

Related color spaces, such as YUV and YIQ, are also linearly related to R′G′B′, but do not occur in digital component video. The YUV color space is used in the formation of analog color signals in the processing of NTSC, PAL and SECAM television signals. The term YUV is often incorrectly used to refer to the YCbCr color space, and even more incorrectly to other color spaces which are derived from the linear RGB color space via linear transformations similar to the R′G′B′ to YCbCr transformation given above.

Color space transformation is a point by point process, which implies that an image's spatial sampling structure should be identical for all of its color components when the color space transformation is computed.

In previous generations of computer graphics systems, video display was achieved by means of an video overlay circuit, which fetched and processed video image data and multiplexed that data with primary graphics data just before the digital to analog converter that generates signals to drive the display device. This approach becomes more and more complex as the quality and number of the desired video functions increases. Essentially each displayed video pixel is computed just in time for its display, which can overwhelm the available graphics memory bandwidth, requires an excessively large amount of on-chip memory and needlessly fast signal processing circuits.

### SUMMARY OF THE INVENTION

The present invention is directed to an Video Processing Engine that is an Overlay Filter Scaler (OFS) having a memory to memory video signal processor decoupled from the display that is better able to meet the feature requirements of a computer graphics system while simplifying the design. The memory-to-memory operation of the video signal processor also facilitates the display of more than one video stream by allowing processed images to be placed in the primary graphics buffers for display. This is particularly useful in video conferencing applications, and for displaying multiple live “thumbnails” of various video feeds. In addition, the signal processor can be used as a graphics anti-aliasing filter by having it process 2-D and 3-D computer graphics images before they are written to the primary display buffer. Similarly, the signal processor can also be used as a “stretch-blitter”, to expand or contract graphics as needed.

The video signal procesor is implemented as a dual-pipelined machine that can produce one 4×4 filtered pixel per clock cycle (ie, the output pixel was derived from a 4 by 4 array of 16 source pixels) for higher quality filtering, or two 3×3 filtered pixels per clock cycle using the same hardware. The signal processor has a filter core the can both upsample and downsample images—including doing both operations simultaneously on different color components. This is of some importance when the input format is one of the common YcbCr formats with limited chroma information—the luma data may need to be downsampled, while the chroma may need to be upsampled when converting to RGB for display. If this isn't done, color tends to be washed out of filtered images that are being downsampled. The scaling that can be formed by the filters ranges in a continuum from 16:1 downscaling to 1:32 upscaling. The input stage to the signal processor operates on rectangular blocks of source images so that its fetching efficiency is high when fetching source images from either linear or tiled memories.

In order to reduce the amount of memory and memory bandwidth that is required, to be able to process large images with the high quality provided by the decoupled signal processor, a horizontal upsampling filter is placed in the video overlay system coupled to the display.

The video processing engine also provides temporal synchronization between input video sources, the video signal processor, the primary display and the video overlay system. The functions of the Overlay Filter Scaler consist of:

1. Source Data Cache that maximizes the reuse of source data by processing the source image in vertical stripes.

2. Color Promotion that converts color components from formats with low numbers of bits per, pixel to higher numbers of bits per pixel.

3. Filtering and Scaling that allows creation of a destination image that has different pixel spacing and/or aspect ratio than the source image.

4. Color Matrix Transformation that performs conversions or adjustments to the three color components.

5. Gamma Correction that corrects for display device nonlinearities after color matrix transformation.

6. Color Demotion that can convert color components from higher numbers of bits per pixel to components with lower numbers of bits per pixel, when the output format requires.

7. Color Space Conversion that converts gamma-corrected, color demoted data from one color space to another when the output format requires.

8. Chroma Low Pass Filtering that reduces the bandwidth of the chroma components when required by the output format.

9. Destination Memory Management that packs image data into convenient formats for outputting to display devices.

In further detail:

1) The Source Data Cache:

a) contains a rectangular sub-window significantly wider than it is high

b) is filled in stripes that have a significant amount of overlap

c) to facilitate horizontal or vertical mirroring, can be read in a different order than it was written (forward or reverse for either dimension).

2) Color Promotion:

a) creates additional least significant bits for pixels by replicating higher order (most significant bits) in those positions

i) in practice converts 5-bit components to 8-bit by replicating the three most significant bits as the three least significant bits

ii) or converts 6-bit components to 8-bit by replicating the 2 MSBs as the 2 LSBs.

3) Filtering and Scaling:

a) reference coordinate system is defined by the source image

b) the first coordinate normally increases from left to right

i) mirroring feature allows this coordinate to increase from right to left

c) the second coordinate normally increases from top to bottom

i) mirroring feature allows this coordinate to increase from bottom to top

d) the destination image defines the initial phase of the output image

i) initial phase in the first direction can be positive or negative

ii) initial phase in the second direction can be positive or negative

e) allows for “cropping” of the source image by specifying independent start and stop parameters of the first and second coordinates

f) allows for “scaling” of the source image by specifying independent scale factors for the first and second coordinates

i) first coordinate scale factor can be less than, equal to, or greater than unity

ii) second coordinate scale factor can be less than, equal to, or greater than unity

g) allows all three color components to have same reference coordinate system

h) alternately allows one or more of the color components to have a separate reference coordinate system from the others

i) specific case: YCbCr images where the Y component spacing defines a primary source pixel coordinate system

ii) YCbCr images where the Cb and Cr component spacing (not being equal to the Y component spacing) defines a secondary source pixel coordinate system

i) is based on two-dimensional finite-impulse response (FIR) filters

i) filter operations can be separable in the horizontal and vertical directions

ii) alternately filter operations can be non-separable in the horizontal and vertical directions

iii) filter dimensions can be 3×3 or 4×4 source pixels in size (preferred implementation)

iv) filter tables can be symmetrical in both dimensions, thus saving on the size of the table coefficients which must be stored

v) table coefficients can be either positive and negative

vi) filters could be resampling, smoothing, or edge-enhancement filters

4) Color Matrix Transformation:

a) performs a fine transformations on three-component values of the type: Q=MP+O

i) where P is the 3×1 component vector from the Filtering and Scaling stage,

ii) M is a 3×3 transformation matrix,

iii) O is a 3×1 offset vector, and

iv) Q is the 3×1 component vector produced

b) coefficients of M and O may be positive or negative, greater, equal, or less than unity

c) transformations include flexible color space conversion, brightness adjustment, contrast adjustment, hue adjustment, individual color enhancement, color swapping, image negatives, and transformation into monochrome images.

5) Gamma Correction:

a) can be performed with piecewise linear approximation.

6) Color Demotion:

a) Can be performed with procedure linear approximation.

7) Color Space Conversion:

a) where the input color space could be R′G′B′ 888

b) where the output space could be ITU Rec. 601 YCbCr 4:4:4.

8) Chroma Low Pass Filtering:

a) is required when the desired output spacing of the chroma components is not equal to the spacing of chroma components from the Color Space Conversion stage

b) where the chroma components could be Cb and Cr

c) where the output format could be YCbCr 4:2:2.

9) Destination Memory Management:

a) where the output format may require the color components to be packed into groups that are even multiples of the output devices instruction word width

b) where instruction words may have to be padded with fixed values to align the components properly within the output device instruction word

c) where luma components and chroma components of pixel may have to be combined into single instruction words.

d) where chroma components of certain pixels may have to be discarded.

### BRIEF DESCRIPTION OF DRAWINGS

FIG. 1 is a block diagram showing the video, graphics and display data paths of the video processing engine of the present invention.

FIG. 2 is a block diagram representing a conceptual view of the Overlay Filter Scaler data flow.

FIG. 3 illustrates the OFS cache (scrap buffer) concepts.

FIG. 4 illustrates scaling and cropping concepts.

FIGS. 5 and 6 illustrate contributing pixels and selection of filter coefficients.

FIG. 7 is a block diagram of the Overlay Filter Scaler hardware architecture.

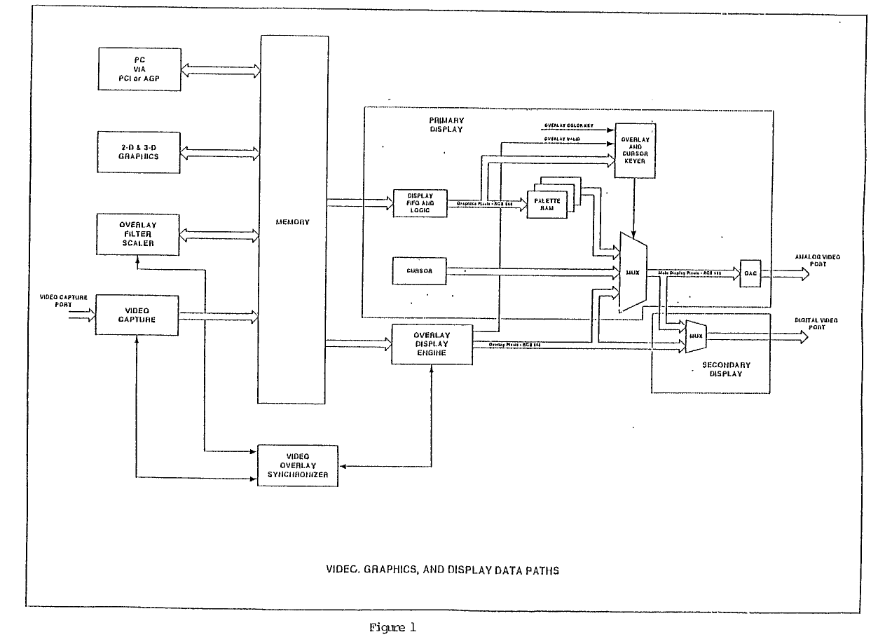

### DETAILED DESCRIPTION OF INVENTION

The Overlay Filter Scaler (OFS) is a comprehensive video processing engine built around a two dimensional digital signal processing core. It performs the scaling, filtering, and format conversion functions in real-time that are needed to meet the requirements of displaying high quality video integrated with the 2-D and 3-D graphics display environments of personal computers and workstations. The OFS reads video or graphics source images that reside in either local memory (graphics memory) or AGP memory (main memory), and writes processed destination images to local memory. The OFS can process images stored in most of the image formats produced by digital video and graphics systems. The sources of images to be processed by the OFS include: (1) external video streams from cameras or playback devices processed by the video capture hardware; (2) DVD video streams processed by the texture pipeline; (3) video conference image streams received from a local or wide-area network; and (4) 3-D graphics images created by the 3-D graphics processors. Because OFS destination images are written back to memory, they may be used as texture maps in 3-D processing, stored for future display, or transmitted to other devices. The OFS is also used as the final processor of 2-D and 3-D graphics to produce anti-aliased images.

The signal processing core of the OFS can be configured as a dual 3×3 filter, where each output pixel is derived from 9 source pixels, or as a single 4×4 filter, where each output pixel is derived from 16 source pixels. When operating in its dual 3×3-filter configuration, the OFS can produce two filtered pixels per clock cycle. When operating in its 4×4-filter configuration, it can produce one filtered pixel per clock cycle. With a 100 MHz system clock, the peak pixel production rates of the OFS are 200 million 3×3 filtered pixels per second or 100 million 4×4 filtered pixels per second.

All OFS image transformation operations are initiated by the Video Overlay Synchronizer (VOS). Scan rate conversions are required when displaying video streams at a source frame rate that is not the same as the display frame rate. Scan rate conversions are performed by using frame replication when the display rate is greater than the source rate, and by frame decimation when the display rate is less than the source rate. Scan rate conversions require the storage of multiple video frames in staging buffers. The VOS coordinates the sequencing of video frames through the staging buffers and the OFS based on timing signals it receives from the video source and the display device.

The Overlay Display Engine (ODE), Primary Display Engine (PDE), and Second Monitor-Flat Panel (SMF) components provide the mechanisms for delivery of OFS destination images to a display device, such as a CRT monitor, TV, or flat panel display. Figure; Video, Graphics, and Display Data Paths, shows the interrelationships between the various graphics and video processing blocks.

As a memory to memory operator, the OFS can process images placed in memory by the main processor, the graphics pipelines, the video capture port, or itself. Images produced by the OFS can be read by the main processor, the graphics pipelines, and either the primary display engine or the overlay display engine. The display of video in a desktop graphics window can be achieved by either instructing the OFS to write processed images to the primary graphics display buffer or by instructing the OFS to write to memory buffers which are then read by the ODE and merged with the graphics display in the primary display engine. The secondary video output can either replicate the primary video output, or be driven with an independent image stream fetched by the ODE. It is possible to have full screen video on the secondary video display with a scaled version of the same video stream appearing in a window on the primary graphics display. Many small live video windows (“thumbnails”) can be displayed by instructing the OFS to process images in sequence from a number of video streams, and to place the resulting scaled images into adjacent memory buffers which are subsets of a common display buffer.

Video Image Spatial Sampling

All image formats processed by the OFS consist of rectangular arrays of image color component samples. The figure Spatial Positions of Video Data Samples illustrates the video image sampling provided by each of the digital video source formats supported by the OFS. In the figure, the top leftmost point in each diagram represents the first pixel of the first video line, with pixel positions increasing to the right, and line numbers increasing downwards. In the four RGB formats, red, green, and blue samples are given at each pixel position.

While video data provided in a YCbCr color space always has Y components provided at every pixel position in the image, Cb and Cr chroma components are usually provided at fewer sample points within the image. This sub-sampling of chroma information is used to save transmission bandwidth and image storage requirements, and takes advantage of the fact the human visual system is less sensitive to chroma information than to luma information. YCbCr 4:4:4 data has Y, Cb, and Cr samples at every pixel, but this format is only used by the OFS when it creates pixels in the format temporarily within its computational pipeline. In the YCbCr 4:2:2 formats, the Y luma samples are given at each pixel position, but the Cb and Cr chroma samples are provided at every other horizontal pixel position. Thus the chroma information in YCbCr 4:2:2 formatted images is provided at one half the rate of the luma information. In YCbCr 4:1:1 images, Cb and Cr samples are provided only at every fourth horizontal pixel position.

YCbCr 4:2:0 formatted source images can be sampled in two different ways, one of which in used in MPEG-1 encoded video, and the other in MPEG-2 encoded video. In both variants of YCbCr 4:2:0 sampling, Y samples are provided at every pixel position, but Cb and Cr samples occur at one-fourth of the rate of the Y sample—one-half of the Y sample rate in both horizontal and vertical directions. In both MPEG-1 data and MPEG-2 data, Cb and Cr samples are given for vertical positions between every second pair of Y sample lines. In MPEG-1 data, the Cb and Cr samples are given for horizontal positions between every second pair of luma samples, while in MPEG-2 data, they are aligned with every other horizontal luma sample.

Another way of describing this is to assume the top leftmost Y sample has the pixel coordinates (0.0, 0.0), the next Y sample in the first line has pixel coordinates (1.0, 0.0), and the first Y sample in the second line is at (0.0, 1.0), and so on. Then the first Cb and Cr samples in MPEG-1 data occur at pixel coordinates (0.5, 0.5). The next Cb and Cr samples in the first row of chroma data is given for coordinates (2.5, 0.5), and the first samples in the second row of chroma data occur are given for pixel coordinates (0.5, 2.5). For MPEG-2 data, the first chroma samples are given for pixel coordinates (0.0, 0.5), the next samples in the first row of chroma data are at (2.0, 0.5), and the first samples in the second row of chroma data are given for pixel coordinates (0.0, 2.5).

YCbCr 4:1:0 formatted source images are sampled similarly to YCbCr 4:2:0 MPEG-1 except that the Cb and Cr samples occur at one-sixteenth of the rate of the Y samples—one-fourth of the Y sample rate in both horizontal and vertical directions. The Y sample grid is exactly the same as YCbCr 4:2:0 MPEG-1 but the first Cb and Cr samples are at pixel coordinates (1.5, 1.5). The next Cb and Cr samples in the first row of chroma data are given at the coordinates (5.5, 1.5), and the first samples in the second row of chroma data are given at the coordinates (1.5, 5.5).

For most video content, a chroma sub-sampled YCbCr representation is superior to an RGB representation when each uses the same number of bits per pixel. For example, both 8-bit component YCbCr 4:2:2 and RGB require 16 bits per pixel. However, images in RGB format can show significant banding effects while no banding is visible in the same images in YCbCr 4:2:2 format.

Video Image Temporal Sampling

When all lines and pixels within an image can be considered as having been sampled at the same point in time, the image is referred to as a frame. A sequence of images captured by a movie film camera is composed of frames. In both conventional television and HDTV video streams, each image is captured in two fields. The first field contains the top line of the image and every second subsequent line. The second field begins with the second line from the top of the image and continues with every second subsequent line. A complete image is obtained by interlacing the lines of the two fields. In North American television standards, the field rate is 59.94 Hz, and the image rate is 29.97 Hz. Interlaced sampling allows video to effectively reproduce scenes with higher motion content at the expense of reducing the vertical resolution of image elements in motion by one half. Interlaced sampling does not reduce the vertical resolution of stationary image elements. Interlacing greatly reduces the amount of flicker that is perceived when viewing television on a CRT based receiver.

When the video format contains vertically sub-sampled chroma (YCbCr 4:2:0 and YCbCr 4:1:0), the first line of chroma samples and every second subsequent line of chroma samples are part of the first field of an image. The second line of chroma samples and every second subsequent line of chroma samples are part of the second field. Unlike other video data formats, the vertical spatial sampling structures of the two fields of YCbCr 4:2:0 and YCbCr 4:1:0 images are not identical. This can be seen in the figure Spatial Positions of Video Data Samples by observing the labels F0 (first field) and F1 (second field).

The process of converting a sequence of alternating fields into a sequence of images by vertically expanding each field of an interlaced video stream into a full frame is called bobbing. Bobbing can be accomplished by line replication, where each synthesized line in a frame is copied from an neighboring field line, or by line interpolation, where each synthesized line is the average of the two neighboring field lines. Both of these techniques and the more general technique of frame based line interpolation, where a synthesized frame line is created from several field lines using a vertical filter, can be accomplished using the filters within the OFS. Because the two fields do not have the same spatial relationship to the reconstructed images, the process of building an image from each of the two fields must be different to avoid creating vertical spatial artifacts in the reconstructed image sequence.

If a sequence of fields contains little motion from field to field, better spatial resolution in creating an image can be obtained by weaving the two fields together. Weaving is also known as field merging. Weaving is accomplished simply by writing two fields into the same memory buffer, alternating lines from each field so that the data in memory forms a complete source frame.

Image artifacts are introduced by bobbing and weaving interlaced frames. Bobbing causes the vertical resolution of all elements of an image, including those with no motion, to be reduced by one-half. Bobbing can also cause pixels vertically close to high contrast boundaries to flicker if the actual boundary lies between two adjacent horizontal lines in the two fields. This effect is known as twitter, and results in the visual perception of rapid local up and down motion. Weaving causes visible motion artifacts in reconstructed images when more than a small amount of motion is present in the source stream.

Better temporal image reconstruction methods than either bobbing or weaving exist. If the amount of motion within the video stream is such that the Nyquist sampling theorem is satisfied temporally (which means that objects move less than one half pixel from one source image to the next), then multiple source images can be temporally filtered to generate output images. This condition is commonly not met, so that other motion compensation techniques must be used. These techniques attempt to quantify the motion in an image sequence by algorithms ranging from those based on block correlation functions to human directed scene analysis. When the motion has been quantified, different reconstruction algorithms are applied to areas of little motion than from those applied to areas of significant motion. Motion compensation depends on the analysis of multiple sequential images and can be computationally expensive. Motion compensation techniques are useful both for scan rate conversions and in image compression algorithms.

Because the OFS processes only one source image at a time, it implements only the bob and weave methods of interlaced image reconstruction. For the same reason, scan rate conversions using the OFS and VOS are limited to image replication and decimation to match input and output scan rates. Scan rate conversion by frame replication and decimation can generate perceptual irregularities in motion portrayal if either the source or display rate is not a multiple of the other.

Some display devices like television monitors can display only interlaced video. The OFS can convert non-interlaced frames to interlaced fields simply by scaling input frames vertically.

The OFS can produce output images in the RGB32, RGB16 and YCbCr 4:2:2 Normal formats.

Image Organization in Memory

The addressable memory units are: bytes; words—2 bytes; double words—4 bytes; quad words—8 bytes; oct words or double quad words (DQW)—16 bytes; and double oct words (DOW)—32 bytes. Addresses of words and larger units are divisible by the number of bytes in the unit. Accesses to AGP memory are made as a sequence of oct word transfers, while accesses to local memory can be made as a sequence of either oct word or double oct word transfers.

A horizontal sequence of pixels within an image is called a line. Pixels within a line occupy ascending memory addresses corresponding to their left to right display order. Images are composed of a vertical sequence of lines which are placed in memory so that lines occupy ascending memory addresses corresponding to their top to bottom display order. The number of pixels in a line is the image's width. The number of lines in the image is its height. The difference between the initial addresses of any two adjacent lines in the image is called the stride, which is required to be divisible by 32. The leftmost pixel and the topmost line of an image are denoted as pixel 0 and line 0 for the purposes of address calculation. In the simplest image formats (the RGB formats), the address of pixel m in line n can be found by the expression: [(Address of pixel 0 in line 0)+stride*n+m*(pixel size in bytes)]. For other image formats the expression is more complex and depends on the structure of the atomic data unit of the format and the placement of the pixel within the atomic data unit.

Images in the RGB formats, the YCbCr 4:2:2 formats, and the YCbCr 4:1:1 format are placed together in a single memory buffer. These formats are called packed to indicate that all of the color components of pixels in the image are placed together in memory. The YCbCr 4:2:0 and 4:1:0 formats are planarformats, where data for each of the three color components is placed in a separate memory buffer. The width and height of the Cb/Cr buffers must be one-half those of the Y buffer for YCbCr 4:2:0 images; for YCbCr 4:1:0 images, the width and height of the Cb/Cr buffers must be one-fourth those of the corresponding Y buffer. There is no defined relationship between the strides of the Y buffer and those of the Cb and Cr buffers other than the requirement that the strides of the Cb and Cr buffers be the same. The OFS also supports a planar YCbCr 4:2:2 format where the width of the Cb and Cr buffers is one-half that of the Y buffer and the height of the Cb and Cr buffers equals that of the Y buffer.

A buffer address points to the first byte of the atomic data unit containing the leftmost pixel or component of the top line of the image. Images may be cropped from the left and the top by changing the buffer address to point to a new upper left corner. Images may be cropped from the right and the bottom by adjusting the width and the height of the image. However, the organization of image data in memory imposes restrictions the permitted granularity of buffer addresses, widths, and heights. These restrictions are necessary to guarantee that the atomic data units of packed formats remain intact, and that the size ratio between the buffers of planar formats remains constant.

OFS Signal Processing Operations and Data Flow

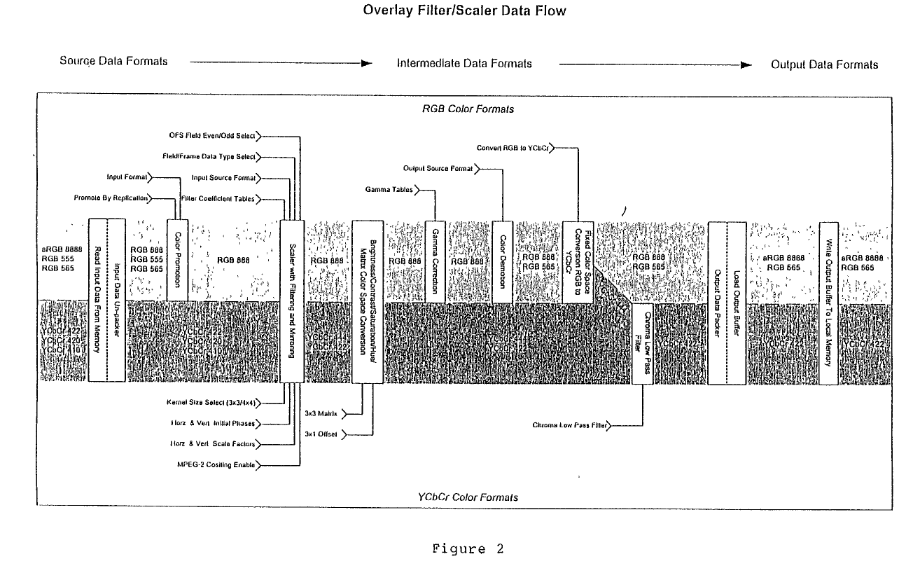

FIG. 2 shows Overlay Filter/Scaler Data Flow and presents a conceptual view of the signal processing operations within the OFS.

Source Data Caching and Image Processing Order

The OFS reads source image data into a cache memory that can store 256 bytes of data from each of four source lines. When the cache has been filled, it contains a rectangular sub-window of the original image that is significantly wider than it is high. To maximize the re-use of source data within the cache, the source image is processed in vertical stripes. The upper left corner of the source image is first copied into the cache, and then destination pixels whose contributing source pixels are in the cache are calculated in left-to-right followed top-to-bottom order. When no destination pixels require the top line in the cache, it is replaced with a line that is below what is currently in the cache. Thus the cache contents and calculated segments of destination lines progress down a vertical stripe. When the bottom of a stripe is reached, the cache is refilled from the top of the next stripe to the right. The overlap penalty is the data that must be refetched along the vertical seams of the stripes due to the width of the filter kernel and the arrangement of source data within double quad words.

The description above applies to the processing of an image without mirroring. If vertical mirroring is performed, source image stripes are processed from bottom to top. If horizontal mirroring is performed, source stripes are processed from right to left.

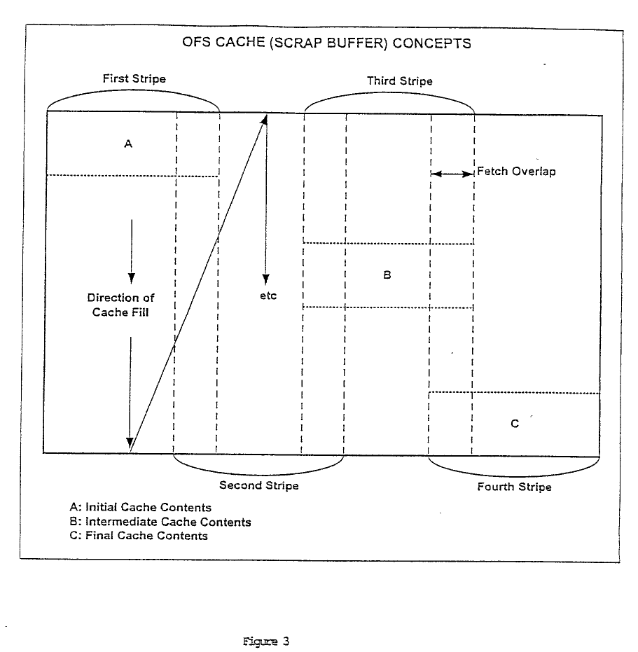

The cache size and fetch policies are designed to be an efficient compromise among the requirements to minimize cache size, minimize the re-fetching of data, minimize the number of memory page faults, maximize memory bandwidth, and to operate well in both linear and tiled memories. FIG. 3 shows OFS Cache (Scrap Buffer) Concepts.

Color Promotion of RGB and RGB15 Formats

Full 8-bit values for all color components are present in the source data for all formats except RGB16 and RGB15. The five and six-bit components of these formats are converted to 8-bit values either by shifting five-bit components up by three bits (multiplying by eight) and six-bit components by two bits (multiplying by four), or by replication. Five-bit values are converted to 8-bit values by replication by shifting the 5 bits up by three positions, and repeating the most significant three bits of the 5-bit value as the lower three bits of the final 8-bit value. Similarly, six-bit values are converted by shifting the 6 bits up by two positions, and repeating the most significant two bits of the 6-bit value as the lower two bits of the final 8-bit value.

C₈=(C₅<<3)|(C₅>>2) for five-bit components

C₈=(C₆<<2)|(C₆>>4) for six-bit components

The conversion of five and six bit components to 8-bit values by replication can be expressed as:

Although this logic is implemented simply as wiring connections, it obscures the arithmetic intent of the conversions. It can be shown that these conversion implement the following computations to 8-bit accuracy:

$$\begin{matrix}{C}_{8} = \frac{255}{31} {C}_{5} for five \text{-} bit components \\ {C}_{8} = \frac{255}{63} {C}_{6} for six \text{-} bit components\end{matrix}$$

Thus replication expands the full-scale range from the 0 to 31 range of five bits or the 0 to 63 range of six bits to the 0 to 255 range of eight bits. However, for the greatest computational accuracy, the conversion should be performed by shifting rather than by replication. This is because the pipeline's color adjustment/conversion matrix can carry out the expansion to full range values with greater precision than the replication operation. When the conversion from 5 or 6 bits to 8 is done by shifting, the color conversion matrix coefficients must be adjusted to reflect that the range of promoted 6-bit components is 0 to 252 and the range of promoted 5-bit components is 0 to 248, rather than the normal range of 0 to 255.

Filtering and Scaling

Geometric Relations Between Source and Destination Pixels

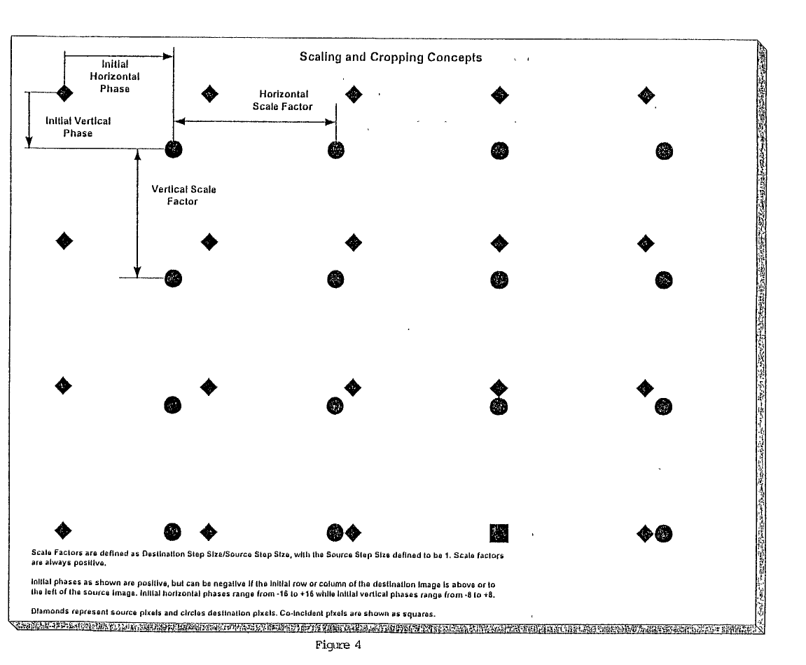

FIG. 4 shows Scaling and Cropping Concepts which are the major concepts required to specify the geometric relationships between source and destination pixels when scaling a source image.

The source image defines the coordinate system that is used in producing destination pixels. The pixel in the upper left-hand corner of the source is taken as the origin, and therefore has the coordinates (0, 0). The first coordinate increases from left to right, with the distance between adjacent source pixels defined as 1, so that the source pixel to the left of the pixel at the origin is located at (1, 0). The second coordinate increases from top to bottom, so that the source pixel beneath the pixel at the origin is at (0, 1). The initial horizontal and vertical phases specify the position of the upper left pixel in the destination image, so that its position has the coordinates (initial horizontal phase, initial vertical phase). Initial phases may be negative, indicating that the location of the upper left destination pixel is either to the left or is above the source image. Negative vertical phases are typically encountered when creating a frame image from the second field of an interlaced video source, since a line must be synthesized in place of the top scan line which is not present in the second field image.

Mirroring changes the reference coordinate system. If the output image is to be mirrored horizontally from the input image, the upper right-hand pixel of the source image is used as the origin, and the first coordinate increases from right to left. If the output image is to be mirrored vertically, lower left-hand pixel of the source image is used as the origin, and the second coordinate increases from bottom to top. Finally, if the output image is to be mirrored both horizontally and vertically, the lower right-hand pixel of the source image is used as the origin and the coordinates increase from right to left as well as from bottom to top.

Adjusting the address pointer of the source image allows source cropping to a granularity that is dependent on the source format. The granularity can be as large as 8 pixels horizontally and 4 lines vertically. To compensate for this limitation, the initial horizontal phase has a maximum magnitude of 16 and the initial vertical phase a maximum magnitude of 8. Adjusting the source image address pointer and the initial phases controls source cropping on the top and left sides of the image. Bottom and right side source cropping are achieved by adjusting the height and width parameters of the source and destination images along with the vertical and horizontal scale factors.

Horizontal and vertical scale factors specify the distances between adjacent destination image pixels. Downscaling requires scale factors greater than one while upscaling requires scale factors less than one. In the figure, the destination image is being upscaled vertically with a vertical scale factor of 0.875 and downscaled horizontally with a horizontal scale factor of 1.125. Both scale factors are provided to the OFS in a 4.15 unsigned format. The maximum scale factor is therefore about 32, corresponding to a reduction in size by a factor of 32. The large number of fractional bits allows destination pixel placement accuracy to be better than one-sixteenth of a pixel across a maximum size destination image (2047 pixels) when upscaling by a factor of 16. When upscaling by a factor of 32, destination pixel placement accuracy is better than one-eighth of a pixel across a maximum size image.

RGB source images have one reference coordinate system for all three color components. YCbCr images with sub-sampled chroma have two reference coordinate systems. For these color spaces, the placement of the luma components defines the primary source pixel coordinate system, and the placement of chroma component samples defines a secondary chroma coordinate system. Without mirroring, the origin of this secondary coordinate system is the location of the upper left chroma samples in the source image. With mirroring, the origin shifts to other corners in the same way as the primary coordinate system.

Contributing Pixels and Selection of Filter Coefficients

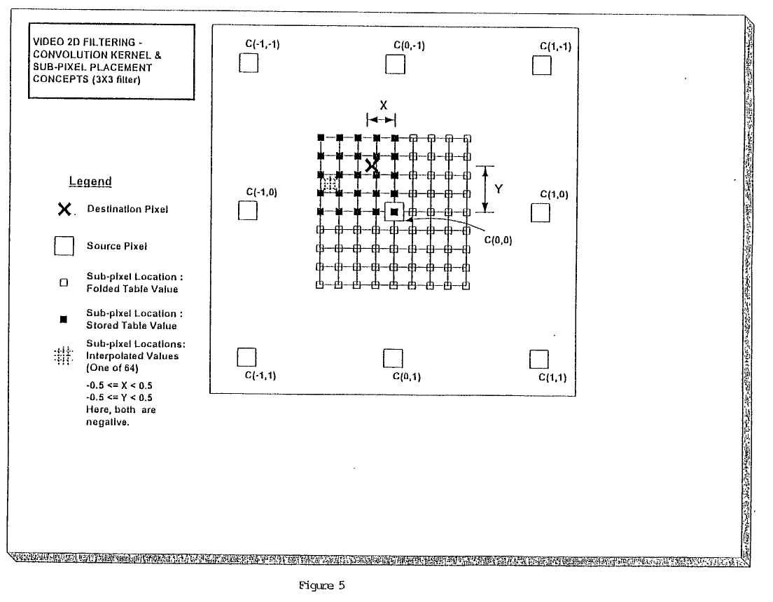

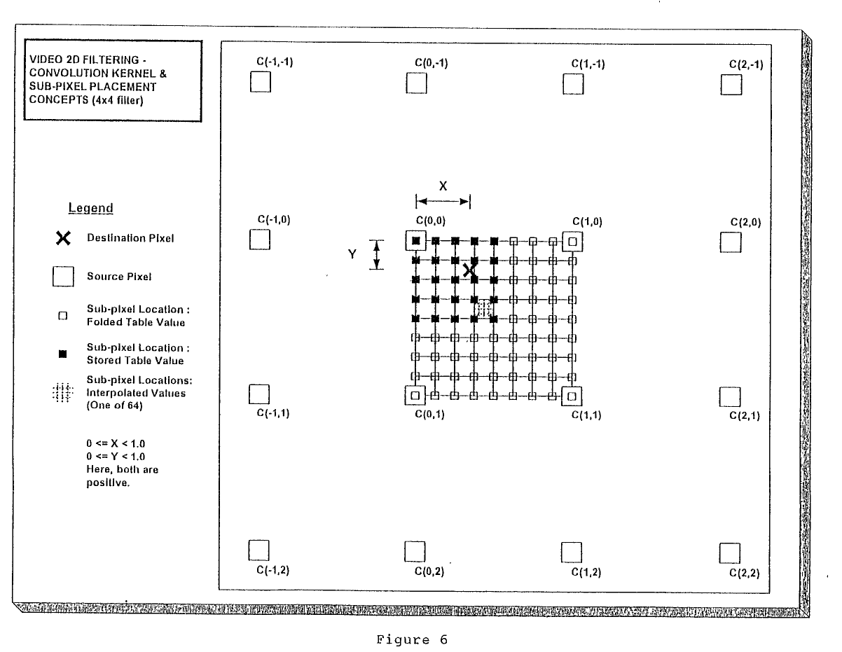

FIGS. 5 and 6 illustrate the selection of the source image pixels that will contribute to a destination pixel. They also show how the sub-pixel placement of a destination pixel is used to select a set of filter coefficients to be used within the filter when it calculates the linear combination of contributing source pixels to form the destination pixel.

For the 3×3 filter configuration, the nine source pixels nearest a destination pixel are used to compute the destination pixel's value. If the destination pixel's coordinates are (X, Y), the reference contributing source pixel, denoted by C(0, 0), is defined to be the source pixel at coordinates (floor(X+0.5), floor(Y+0.5)). With a coordinate system translated to a new origin at C(0, 0), the nine contributing source pixels will have coordinates ranging from (−1, −1) to (1, 1). The coordinates of the destination pixel in the new system will be (x, y)=(X−floor(X+0.5), Y−floor(Y+0.5)). Then −0.5<=x<0.5 and −0.5<=y<0.5, so that the destination pixel lies within a square whose sides have a length of 1 centered at the reference pixel. Superimposed on this square is a sub-pixel grid composed of 81 points located at increments of one-eighth of a pixel vertically and horizontally. The coordinates of the destination pixel, (x, y), are rounded to the nearest sub-pixel grid point, which is then used as an index to retrieve the set of filter coefficients for the computation of the destination pixel.

For the 4×4 filter configuration, the sixteen source pixels nearest a destination pixel are used to compute the destination pixel's value. If the destination pixel's coordinates are (X, Y), the reference contributing source pixel, denoted by C(0, 0), is defined to be the source pixel at coordinates (floor(X), (floor(Y)). With a coordinate system translated to a new origin at C(0, 0), the sixteen contributing source pixels will have coordinates ranging from (−1, −1) to (2, 2). The coordinates of the destination pixel in the new system will be (x, y) (X−floor(X), Y−floor(Y)). Then 0<=x<1 and 0<=y<1, so that the destination pixel within a square whose sides have a length of 1 centered at (0.5, 0.5). Superimposed on this square is a sub-pixel grid composed of 81 points located at increments of one-eighth of a pixel vertically and horizontally. The coordinates of the destination pixel, (x, y), are rounded to the nearest sub-pixel grid point, which is then used as an index to retrieve the set of filter coefficients for the computation of the destination pixel.

If the preceding constructions cause the selection of source pixels with coordinates that are outside of the source image, the source image can be extended in one of two ways. The non-existent pixels can be substituted with black level pixels, which has the effect of processing the source image as if were placed on a black background. RGB black level pixels have component values of (0, 0, 0), and YCbCr (ITU Rec. 601) black level pixels have component values of (16, 128, 128). Alternatively, data for the off-image pixel locations can be obtained by copying data from the nearest on-image source pixels.

Filtering is performed on a component by component basis by three filter banks. For RGB source images, these banks produce filtered red, green, and blue output components. Similarly for YCbCr source images, the three filter banks produce filtered Y, Cb, and Cr output components for every destination pixel. The selection of contributing source samples and filter coefficients for luma components is based on the location of the destination pixel in the primary source coordinate system. The selection of contributing source samples and filter coefficients for the chroma components is based on the location of the destination pixel in the secondary source coordinate system. The scaling of YCbCr images with sub-sampled chroma requires two sets of scale factors as well as two sets of filter coefficient tables, one for the luma components and one for the chroma components. The secondary chroma scale factors are derived within the OFS from the specified primary scale factors. The primary filter tables are used for computing filtered luma components and the secondary filter tables are used for computing filtered chroma components. To simplify the filter circuitry, the primary filter tables are used for computing filtered red components, and the secondary tables for filtered green and blue components. Therefore, the secondary filter tables must be identical to the primary tables when filtering RGB source images.

The filter tables required for scaling and most other video signal processing functions are symmetrical both vertically and horizontally about the center sub-pixel -grid point for both 3×3 and 4×4 filter configurations. Therefore the number of tables that are stored within the OFS has been reduced from 81 to 25 in each of the primary and secondary sets. The stored filter tables are those of the 5×5 sub-pixel grid in the upper left hand quadrant of the larger 9×9 sub-pixel grid. Filter tables for destination pixel locations within the remaining three quadrants are obtained from those of the upper left hand quadrant by reflecting the association between contributing source pixels and a filter table either horizontally, vertically, or both about the center of the sub-pixel grid when the sub-pixel location of the destination pixel is in the upper right, lower left, or lower right quadrant, respectively.

Each of the 25 primary filter tables and the 25 secondary filter tables contains sixteen coefficients for use in the 4×4 filter configuration. In the 3×3 filter configuration, only nine of these sixteen coefficients are used. Each filter coefficient is an 11-bit signed two's complement number with three integer bits and eight fractional bits.

Resampling (Scaling) Filters

Because all of the image formats processed by the OFS have a rectangular sample structure, and horizontal and vertical image scaling are performed independently, the filter structures required for scaling are separable, or factorable into independent vertical and horizontal one-dimensional resampling filters. The action of a (one-dimensional) resampling filter can be thought of as first reconstructing the original continuous signal from which the input samples were obtained, and then sampling the reconstructed continuous signal at the desired output sample rate. This type of multirate digital signal processing forms the core of the filtering capabilities within the OFS. In image processing, sample rates are measured horizontally in samples (pixels) per line and vertically in lines per image.

Ideal upscaling occurs when the discrete spectrum of the original sequence from −π to π is mapped to the range (−π scale factor) to (π scale factor) in the spectrum of the resampled sequence, and the magnitude of the spectrum of the resampled sequence is zero from frequencies of (π scale factor) to π. For scale factors of 1/n, where n is an integer, this can be done by inserting (n−1) zeros between samples of the original sequence and then low-pass filtering this new sequence with a cut-off frequency of (π/ n) to remove the high frequency replicas of the original sequence's spectrum. For upscaling by an arbitrary scale factor less than 1, each resampled output value is given by the following expression, where dₖ is the distance between the output sample's location and that of the kth input sample, and Vₖ is the value of the kth input sample:

$${\sum }_{k} \frac{sin ( π {d}_{k} )}{π {d}_{k}} {V}_{k} k ranges over all source samples$$

Ideal downscaling occurs when the discrete spectrum of the original sequence from (−π scale factor) to (π/scale factor) is mapped to the range −π to π in the spectrum of the resampled sequence. This preserves the maximum amount of the original sequence's information content and avoids aliasing by discarding high frequency information that cannot be retained in the lower rate output. For scale factors of

$${\sum }_{k} \frac{sin ( π {d}_{k} / sf )}{π {d}_{k} / sf} {V}_{k} k ranges over all source samples$$

k ranges over all source samples n, where n is an integer, this can be done by low-pass filtering the original sequence with a cut-off frequency of (π/n), and then retaining only every nth filtered sample. For downscaling by an arbitrary scale factor greater than 1, each resampled output value is given by the following expression, where sf represents the scale factor:

Since these expressions for ideal resampling filters are based on the distance of an output sample to the input sequence's samples, they are also valid expressions for the filters required to shift a input sequence by a fraction of the distance between input samples. Thus they represent a general set of filters that perform both scaling and shifting operations. Although the ideal filters require a number of filter taps equal to the number of samples in the source sequence, they can be approximated by filters with a limited number of taps that sum only those terms containing source sequence samples that are the nearest neighbors to an output sample.

Measured at the source sample rate, the discrete spectrum of the ideal upscaling filters is flat across all frequencies, and the spectrum of the ideal downscaling filters is flat up to the cut-off frequency and zero beyond it. The frequency responses of the truncated ideal filters are deficient in several respects. As the location of an output sample moves toward the mid-point of two source samples, the upscaling filters show more and more low-pass characteristics. Although the cut-off frequencies of the truncated filters increases as the number of filter taps is increased, the number of filter taps is fixed. The pass-bands of these filters have significant ripple, and the shape of the pass-band varies significantly with the fractional location of the output pixel. The pass-bands of the filters can be made flatter, and therefore more equal to each other, if the filter coefficients are changed from their sinc function values by multiplying them by a window function that is centered on the location of the output pixel. Both raised cosine and triangular pulses, among others, are effective window functions.

When the unmodified truncated filters are used to scale an image, the output images can show a significant amount of ghosting or ringing at high contrast edges. In the spatial domain, this effect can be attributed to large negative weights in the outer taps of the filter. The use of a windowed filter reduces these tap weights and thereby reduces the ghosting effect. Some ghosting is can be tolerated, since human viewers tend to regard images with a small amount of it as sharper or crisper.

A set of resampling filter coefficients for the 3×3 and 4×4 filters of the OFS based on these ideas is presented below. For an output pixel at location (x, y) in the Video 2-D Filtering figures, coefficients for each of the contributing source pixels are derived. Contributing source pixels are denoted by C(i, j), where i and j range from −1 to 1 for the 3×3 filter configuration and from −1 to 2 for the 4×4 filter the following expressions, the horizontal scale factor is represented by hfs and the vertical scale factor by vsf.

$$if [ i - x ] = 0 , {s}_{i} = 1 ; else if hfs <= 1 , {s}_{i} = \frac{sin ( π [ i - x ] )}{π [ i - x ]} ; otherwise {s}_{i} = \frac{sin ( π [ \frac{i - x}{hsf} ] )}{π [ \frac{i - x}{hsf} ]}$$

$$if [ j - y ] = 0 , {s}_{j} = 1 ; e lse if vfs <= 1 , {s}_{j} = \frac{sin ( π [ j - y ] )}{π [ j - y ]} ; otherwise {s}_{j} = \frac{sin ( π [ \frac{j - y}{vsf} ] )}{π [ \frac{j - y}{vsf} ]}$$

n=the number of vertical or horizontal taps.

For a triangular window function:

$$if hsf < 1 , {w}_{i} = 1 - \frac{\vert i - x \vert}{floor ( \frac{n}{2 } + 1 )} ; otherwise {w}_{i} = 1 - \frac{\vert i - x \vert}{hsf floor ( \frac{n}{2} + 1 )}$$

$$if vsf < 1 , {w}_{j} = 1 - \frac{\vert j - y \vert}{floor ( \frac{n}{2 } + 1 )} ; otherwise {w}_{j} = 1 - \frac{\vert j - y \vert}{vsf floor ( \frac{n}{2} + 1 )}$$

For a raised cosine window function:

$$if hsf < 1 , {w}_{i} = 0.5 ( 1 + cos ( πi - \frac{x}{floor ( \frac{n}{2} + 1 )} ) ) ; otherwise {w}_{i} = 0.5 ( 1 + cos ( πi - \frac{x}{hsf floor ( \frac{n}{2} + 1 )} ) )$$

$$if vsf < 1 , {w}_{j} = 0.5 ( 1 + cos ( πj - \frac{y}{floor ( \frac{n}{2} + 1 )} ) ) ; otherwise {w}_{j} = 0.5 ( 1 + cos ( πj - \frac{y}{vsf floor ( \frac{n}{2} + 1 )} ) )$$

Then let kᵢ=sᵢ wᵢ and kⱼ₌ₛⱼ wⱼ

and set kᵢⱼ=kᵢ kⱼ

Finally,

$${c}_{ij} = \frac{{k}_{ij}}{{\sum }_{i} {\sum }_{j} {k}_{ij}}$$

is the coefficient for source pixel C(i, j)

The floor functions in the expressions for the window functions can be adjusted to alter the window functions. The window functions given in the formulas for downscaling filters become flatter as the scale factor increases. As the scale factor increases, the unmodified sinc function weights become more equal as the filters need to exhibit more low-pass behavior. In these cases, over-attenuation of outlying source samples by a window function adds unwanted high frequency gain to the filters, and causes aliasing in the output sequence.

For upscaling by a scale factor of 1/n, where n is an integer, the operation of these 3 and 4 tap filters is identical to the operation of 3n and 4n tap low-pass filters acting on a sequence derived from the source sequence by inserting (n−1) zeros between source samples.

The human visual system is very sensitive to changes in brightness levels across an image. In the final expression for the filter coefficients, the denominator serves to normalize the sum of the coefficients to 1 so that resampling does not introduce variations in the intensity of output pixels across the image. For the same reason, any difference between the sum of the coefficients and 1 due to round-off errors in coefficient representation should be distributed proportionally among the numerically largest coefficients.

The resampling coefficient formulas show that a different filter is required for each possible sub-pixel location of the output pixels. In addition, each output sample is derived from input samples on all sides. Thus resampling filters are shift-variant non-causal linear filters. Because each output value is computed without feedback from other output values, the resampling filters are also finite-impulse response (FIR) filters. The architecture of the OFS filter circuits and coefficient storage is built on this mathematical foundation of point sampling filters.

Resampling filters can also be derived using a number of interpolation methods ranging from first-order interpolation to Lagrange polynomial interpolation. The coefficients for geometric area averaging resampling filters are computed from the percentage of the area of the output pixel that contributing source pixels overlap. The area occupied by an square or rectangular input image pixel is considered to be 1 pixel by 1 line, and the pixel's center is the coordinates of the pixel. The lengths of the sides of an output pixel are given by the scale factors. When an image is significantly downscaled, the difference between a geometric averaging filter and a point resampling filter is small. When an image is upscaled or shifted, geometric averaging filters tend to blur edges and thereby produce images that are less sharp than can be obtained with a point resampling filter. Images can be also be scaled by bilinear interpolation where each output pixel is a linearly interpolated vertically and horizontally based on its distances from its four closest source pixels. Finally, images can be scaled by the generally inferior method of replication and decimation of source pixels.

The filter structure of the OFS can accommodate all of the resampling methods discussed above. For instance, the coefficients for a replication/decimation filter are all zero except for the source pixel nearest the output pixel. For this source pixel, the filter coefficient is 1.

Other Filters

Non-resampling filters, such as smoothing or edge-enhancement filters, can be implemented by the OFS filter circuits. For example, a 4-tap horizontal edge enhancement filter can be implemented with the following filter table:

$$[ \begin{matrix}0 & 0 & 0 & 0 \\ - 0.75 & - 1.75 & 2.25 & 1.25 \\ 0 & 0 & 0 & 0 \\ 0 & 0 & 0 & 0\end{matrix} ]$$

When each output pixel is computed, it is located at the C(0,0) source pixel location, which corresponds to the filter tap with weight −1.75.

The filter table for a separable non-resampling filter is given by the n by n matrix product [H][V], where [H] is the n by 1 vector of horizontal filter taps and [V] is the 1 by n vector of vertical filter taps. The OFS can implement both separable and non-separable non-resampling filters simply by providing it with the appropriate filter tables.

In each dimension, the true concatenation of an m-tap non-resampling filter followed by an n-tap resampling filter requires a filter with (m+n−1) taps. However, the effect of such a filter structure can be approximated in many cases by altering the window function weights of the resampling filter. For example, to approximate the action of the horizontal edge enhancement filter followed by a 4×4 resampling filter, multiply each c_{-1,j} by −0.75, each c_{0,j} by −1.75, each c_{1,j} by 2.25, each c_{2,j} by 1.25 and then renormalize the coefficients. This approximation works better for upscaling than for downscaling, and it is not at all suitable when the downscaling ratio is large. An iterative technique such as the Parks-McClellan algorithm can be used for determining optimal filter tables, especially when equalizing the pass-band responses of a set of resampling filters.

Filter Inputs and Outputs

RGB components are provided to the filter as unsigned 8-bit quantities. Y components are also provided to the filter as unsigned 8-bit values. Cb and Cr components are provided to the filter as two's complement signed 8-bit values, so that excess-128 coded values are converted to two's complement codes before entering the filter.

When operating in the 3×3 configuration, the filter accepts two sets of 9 three-component values (54 values) and produces two sets of three-component outputs (6 filtered values) per clock tick. When operating in the 4×4 configuration, the filter accepts one set of 16 three-component values (48 values) and produces one set of three-component outputs (3 filtered values) per clock tick.

All color component outputs of the filter are two's complement signed 9-bit quantities. When the filter is processing RGB source images, it produces RGB output pixels. When the filter is processing YCbCr images, it produces Y, Cb, and Cr components for every output pixel. The contents of the secondary filter table determine whether the output stream is YCbCr 4:4:4, where components are provided for every pixel location, or the output stream is YCbCr 4:2:2. When the output stream is YCbCr 4:2:2, the Cb and Cr components at odd horizontal output pixel locations will simply be discarded at the end of the OFS processing pipeline.

Filter Accuracy

The necessary range and precision was determined empirically by comparing the hardware accurate filter stage with an ideal model using full 32-bit floating point accuracy for. It was determined that there was less than 20 dB RMS error when resampling a full range of valid scale factors using a Normalized Separable Sinc filter kernel. 20 dB RMS error is the visual threshold considered acceptable for consumer video. The Normalized Separable Sinc filter was selected for determining the range an precision because of it naturally contains a wide range of both positive and negative values which give the filter its inherent sharpening characteristic.

Color Matrix Transformations

The OFS Color Matrix block performs affine transformations on the three-component values received from the filter. These transformation can be represented by the following expression:

Q=MP+O

P is the 3×1 component vector from the filter, M is a 3×3 transformation matrix, O is a 3×1 offset vector and Q is the 3×1 component vector produced by the color matrix block.

Color space transformations and color adjustments, including brightness, contrast, and hue adjustments, can all be represented as this type of transformation. The versatility of a full affine transformation block comes from the fact that the concatenation of affine transformations is also an affine transformation. For instance, suppose that

Q₁=M₁ P+O₁ and Q₂=M₂ Q₁+O₂

then

Q₂=(M₂ M₁)P+(M₂ O₁+O₂)

Therefore, the OFS color transformation block can perform any sequence of desired affine transformations when it is loaded with the appropriate coefficients for the matrix M and the offset vector O. Some of the more common transformations are defined below.

Definition of Terms

Gamma corrected R′G′B′ component vector, component range is full scale 0 to 255:

$${R}^{′} = [ \begin{matrix}{r}^{′} \\ {g}^{′} \\ {b}^{′}\end{matrix} ]$$

ITU Rec. 601 or 709 YCbCr component vector, Y component range is 16 to 235, Cb and Cr component range is −112 to 112 (two's complement). Subscript on Y vector indicates whether 601 or 709 color primaries are being used:

$$Y = [ \begin{matrix}y \\ cb \\ cr\end{matrix} ]$$

Transformation matrix for color space conversion from full range R′G′B′ to ITU Rec. 601YCbCr:

$${T}_{Y601} = [ \begin{matrix}0.25678906250 & 0.50412890625 & 0.09790625000 \\ - 0.14822265625 & - 0.29099218750 & 0.4391484375 \\ 0.43921484375 & - 0.36778906250 & - 0.07142578125\end{matrix} ]$$

Transformation matrix for color space conversion from ITU Rec. 601YCbCr to full range R′G′B′:

$${T}_{R601} = [ \begin{matrix}1.16438281250 & - 0.0180078125 & 1.59602734375 \\ 1.16438281250 & - 0.39176171875 & - 0.81296875000 \\ 1.16438281250 & 2.01723046875 & - 0.00119921875\end{matrix} ]$$

Transformation matrix for color space conversion from full range R′G′B′ to ITU Rec. 709 YCbCr:

$${T}_{Y709} = [ \begin{matrix}0.18178906250 & 0.61200390625 & 0.06167968750 \\ - 0.18593750000 & - 0.62597656250 & 0.81191406250 \\ 0.68906250000 & - 0.62597656250 & - 0.06308593750\end{matrix} ]$$

Transformation matrix for color space conversion from ITU Rec.709 YCbCr to full range R′G′B′:

$${T}_{R709} = [ \begin{matrix}1.16894921875 & 0.0000000000 & 1.14285937500 \\ 1.16894921875 & - 0.11517968750 & - 0.33946875000 \\ 1.16894921875 & 1.15285937500 & 0.00000000000\end{matrix} ]$$

Offset vector for 2's complement YCbCr to R′G′B′ and R′G′B′ to 2's complement YCbCr color space conversions:

$${O}_{csc} = [ \begin{matrix}16 \\ 0 \\ 0\end{matrix} ]$$

Brightness color adjustment offset vector. b is positive to increase brightness, and negative to decrease brightness:

$$B = [ \begin{matrix}b \\ 0 \\ 0\end{matrix} ]$$

Contrast and saturation color adjustment matrix. c is always positive and greater than 1 to increase contrast, and less than 1 decrease contrast. Values of s greater than 1 increase color saturation, and values less than 1 decrease color saturation; s is always positive.

$$C = [ \begin{matrix}c & 0 & 0 \\ 0 & s & 0 \\ 0 & 0 & s\end{matrix} ]$$

Hue color adjustment matrix:

$$H = [ \begin{matrix}1 & 0 & 0 \\ 0 & cos θ & sin θ \\ 0 & - sin θ & cos θ\end{matrix} ]$$

Basic Color Space Conversion Calculations

Y₆₀₁=T_{Y601} R′+O_{csc}

R′=T_{R601} Y₆₀₁ −T_{R601} O_{csc}

Combined Color Adjustments and Color Space Conversion Calculations

Simultaneous brightness, contrast, saturation, and hue adjustments to a YCbCr image:

Yₒᵤₜ=(C H)Yᵢₙ+(−C H O_{csc}+O_{cxc}B)

YCbCr color adjustments following color space conversion from full range R′G′B′:

Y₆₀₁=(C H T_{Y601})R′+(O_{csc}+B)

YCbCr color adjustments followed by color space conversion to full range R′G′B′:

R′=(T_{R601} C H)Y₆₀₁+(−T_{R601} C H O_{csc}+T_{R601} B)

Conversion of full range R′G′B′ to YCbCr, followed by YCbCr color adjustments and then conversion back to full range R′G′B′:

R′ₒᵤₜ=(T_{R601} C H T_{Y601})R′ᵢₙ+T_{R601} B

Conversion of Rec. 709 YCbCr to Rec. 601 YCbCr, followed by YCbCr color adjustments:

Y₆₀₁=(C H T_{Y601} T_{R709})Y₇₀₉+(−C H T_{Y601} T_{R709} O_{csc}+O_{csc}+B)

Conversion of Rec. 709 YCbCr to Rec. 601 YCbCr, followed by YCbCr color adjustments, and then conversion to full range R′G′B′:

R′=(T_{R601} C H T_{Y601} T_{R709})Y₇₀₉+(T_{R601} C H T_{Y601} T_{R709} O_{csc}+T_{R601} B)

Other Transformations

The color matrix block can be used for the creation of a variety of special effects: red, green, or blue color enhancement, color swapping, image negatives, and the transformation of color images into black and white images. All of these effects and their concatenation with other transformations are accomplished by the setting of appropriate coefficient values for M and O.

Color Matrix Block Inputs and Outputs

Input vector components are received from the filter as signed two's complement 9-bit values. This implies that Cb and Cr components are received from the filter in two's complement representation rather than in the excess-128 representation used in the ITU definitions of YCbCr. The output vector components are 8-bit values. When the output color space is YCbCr, output Y components are unsigned values clamped to a range of 16 to 235, and output Cb and Cr components are excess-128 values clamped to a range of 16 to 240. Otherwise, the output vector components are considered to be unsigned values and are clamped to a range of 0 to 255.

If the filter is providing either RGB or YCbCr 4:4:4 data, all color transformations are possible. If YCbCr 4:2:2 data is being provided, there are no valid transformations to RGB color spaces, and the only valid output format is YCbCr 4:2:2.

The coefficients of the matrix M are 14-bit two's complement values containing a sign bit, 3 integer bits, and 10 fractional bits. The coefficients of the offset vector O are 16-bit two's complement values containing a sign bit, 11 integer bits, and 4 fractional bits. M and O should be computed by using double precision floating point calculations, particularly when they are obtained from a long sequence of matrix multiplications.

The color matrix block produces output vectors at the same rate that input vectors are received from the filter.

Color Matrix Accuracy

The necessary accuracy was determined empirically by comparing the hardware accurate color matrix stage with an ideal model using a full precision 32-bit floating point matrix coefficients. It was assumed that precision was most important within a brightness range of −128 to 128, contrast range of 0.0 to 3.0, saturation range of 0.0 to 3.0, hue range of −π to π, color space conversion between RGB and YCbCr. Using several combinations of these color adjustments within the above specified ranges and while performing color space conversion there was less than 20 dB RMS error for a full spectrum of color values. 20 dB RMS error is the visual threshold considered acceptable for consumer video.

Gamma Correction

All color components produced by the color matrix block are processed by a gamma correction block. This block computes a sixteen segment piece-wise linear transfer function that can be used as a close approximation to the variable exponential transfer functions that are required for gamma adjustments. The piece-wise linear computation performed on each input color component is:

output=bias+slope (input mod 16), clamped to a range of 0 to 255

The bias and slope are obtained from a look-up table addressed by the upper four bits of the input value. The bias is an unsigned 8-bit integer, and the slope is an unsigned 8-bit value with 3 integer bits and 5 fractional bits. Thus the slope can range from 0 to almost 8 in increments of 0.03125. Three independent look-up tables are used, one for each color component.

This block can be used to convert RGB data to R′G′B′ data and vice-versa. It can also be used to create a composite non-linear transfer function that first inverts the CRT gamma correction function of R′G′B′ data and then compensates for the non-linear intensity function of a non-CRT display, such as an LCD screen.

When gamma correction is not desired, such as when YCbCr data is being processed, the look-up table must be programmed so that the output value equals the input value. This is accomplished by setting the table values so that bias(i)=16* i, and slope(i)=1.

Gamma Accuracy

The necessary accuracy was determined empirically by comparing the hardware accurate gamma correction stage with an ideal model using a full unsigned 8-bit table-look-up. It was assumed that precision was most important within a gamma range of 0.3 to 3.0. Within this gamma range there was less than 20 dB RMS error when gamma correcting a full spectrum of color values. 20 dB RMS error is the visual threshold considered acceptable for consumer video.

RGB 888 to RGB 565 Color Demotion

If the destination image format of the OFS is RGB 565, the color demotion block will receive RGB 888 data from the gamma correction block. The computations performed by this block when the demotion is requested are:

$${R}_{5 - bits} = \frac{31}{255} {R}_{8 - bits}$$

$${G}_{6 - bits} = \frac{63}{255} {G}_{8 - bits}$$

$${B}_{5 - bits} = \frac{31}{255} {B}_{8 - bits}$$

The computations are performed so that the resulting components are the nearest five and six bit integers to these values. If the output format is not RGB 565, this block does not alter component values.

Fixed Color Space Conversion: R′G′B′ 888 to Rec. 601 YCbCr 4:4:4

Data that has been non-linearly transformed by the gamma correction block is in an RGB or R′G′B′ 888 color space. If the output format of the OFS is YCbCr 4:2:2, the R′G′B′ pixels produced by the gamma correction block must first be converted to YCbCr 4:4:4 pixels before subsequent conversion to YCbCr 4:2:2. Therefore this block enables the OFS to convert non-gamma corrected RGB data to gamma corrected R′G′B′ and then into YCbCr data for storage or display.

The transformation equations used in this block are fractional fixed point equations equivalent to the equations given in section 0 for the ITU Rec. 601 conversion of full range R′G′B′ pixels to YCbCr 4:4:4 pixels. If the conversion is not enabled, the block transparently copies its input data to its output.

Chroma Low Pass Filtering

When the output format of the OFS is YCbCr 4:2:2, the input to this block is either a sequence of YCbCr 4:4:4 pixels or a sequence of YCbCr 4:2:2 components directly from the filter. This block sub-samples the YCbCr 4:4:4 chroma components at every even horizontal pixel location with a fixed one-dimensional horizontal filter with taps of [0.25, 0.50, 0.25]. Chroma components at the odd pixel locations to the left and right of the even pixels are weighted with the 0.25 valued taps, while the chroma components at the even pixel locations are weighted with the 0.50 valued tap.

When the low pass chroma filter is engaged, the OFS computes the components of a pixel that is one pixel to the left of the left most output pixel. The chroma components of the additional pixel are used to initialize the chroma filter at the beginning of each destination line.

The chroma low pass filter should be configured to be transparent when it is presented with YCbCr 4:2:2 data.

Writing Destination Images to Memory

At the end of the OFS processing pipeline, image data can be in RGB 888, RGB 565, or YCbCr 4:2:2 formats. This data is first packed into double oct words based on the location of output pixels in the destination image. To store RGB 888 data in the RGB 32 format, an additional byte must be added to every three bytes that make up each output pixel. This additional byte is given the value OxFF and is stored as the high order byte of a 4 byte pixel group. Chroma components for YCbCr 4:2:2 data is provided for every pixel, so that the chroma components at odd horizontal pixel locations must be discarded. YCbCr 4:2:2 pixels are packed into 4 byte atomic units containing the luma and chroma components of even pixels and the luma component of the odd pixel to the right of the even pixel. When data arrives from the pipeline that must be stored in a new double oct word, the current double oct word and its memory address are loaded into an output FIFO. A write state machine makes memory write requests to transfer the double oct words in the FIFO to local memory. Memory requests are made when the FIFO depth exceeds a programmable watermark, or when the pipeline has signaled that it has delivered all of the destination image's data to the FIFO.

OFS Hardware Architecture and Operation

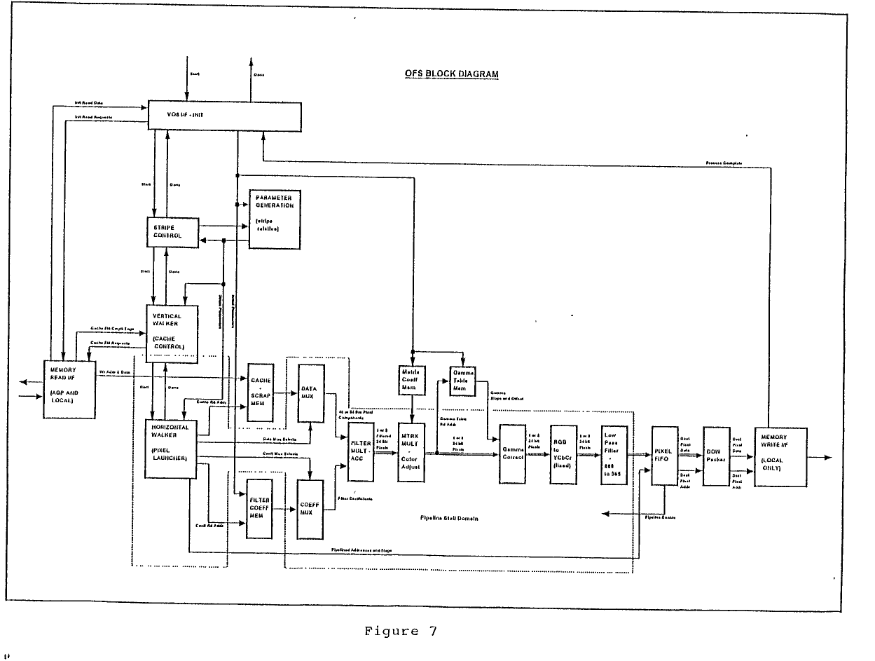

FIG. 7 is a high level block diagram of the OFS hardware. The OFS consists of a highly pipelined computational core surrounded by controlling state machines and memory interfaces.

VOS Interface and Initialization

The top level state machine is the VOS Interface and Initialization block. When a start command is received from the VOS, this block retrieves the all of the parameters required to scale and filter an image from an attribute list in memory. Data from the attribute list is copied into parameter registers and the memories, which are used as coefficient look-up tables by the computational pipeline. After this initialization is complete, the block passes control to the Stripe Control state machine by issuing it a start command. It then waits for indications that image processing has completed, which are generated by the Stripe Control state machine and the memory write interface. When image processing has been completed, the VOS interface signals the completion to the VOS, and the OFS is then ready to process another image.

The attribute list contains:

Pointers to eight source image buffers

Pointers to eight destination image buffers

Source and destination image strides, heights and widths

Source and destination image format codes

The initial horizontal phase of the destination image

Two initial vertical phases for the destination image—one is used with frame source images and also with field 0 interlaced source images, while the other is used only with field 1 interlaced source images

Horizontal and vertical scale factors

Biases and slopes for the red, green, and blue gamma correction functions

Coefficients of the color space transformation matrix and offset vector

16 coefficients for each of the 25 primary and secondary filters

Filter kernel configuration select (dual 3×3 or single 4×4)

Vertical and horizontal mirroring controls

All other control bits that affect the operation of the OFS

The start command from the VOS contains the memory address of attribute list, and indicates which of the source and destination image buffers are to be used by the OFS and which of the vertical phases is to be used if the source image is an interlaced field. Because the tables in the attribute list are large and because the contents of the tables tends to change infrequently, the start command can instruct the OFS to begin processing an image without fetching the parameter tables from memory. This can be done after the OFS has already loaded its tables as a result of a previous start command.

When the OFS signals completion to the VOS, it provides it with the addresses of source and destination buffers retrieved from the attribute list. The VOS uses this information to manage the use of buffers by image producers and consumers. The VOS can also instruct the OFS to signal completion as soon as it has retrieved the buffer addresses from memory without creating a destination image.

Stripe Control and Parameter Generation

The OFS calculates destination pixels from horizontal slices of vertical stripes of the source image. The width of the vertical stripes is determined by how many pixels in a line of the source can be placed into the data cache. The computational pipeline, the Horizontal Walker, which controls the pipeline, and the Vertical Walker/cache controller all base their operations on source and destination image parameters that are relative to the current vertical stripe. The stripe-relative parameters are calculated from the original image parameters and the location of the vertical stripe within the source image by the parameter generation block.

Parameter generation is done by two subsidiary blocks: Image_lnit and Image_Update. Image_lnit generates the derived image attributes that are distributed through the OFS, and the initial values of the image descriptors which are used by Image_Update to calculate stripe-relative parameters. Image_Update operates on image descriptors and stripe-relative positional information provided to it from either Image_Init (for the first stripe) or the Horizontal Walker (for subsequent stripes). Image_Update updates the source image descriptors as the stripes are consumed, and derives stripe descriptors and stripe relative positional information that is provided to the Vertical and Horizontal Walkers. The computation of this data is complicated by the large number of source data formats, variations in source data alignments in memory, and mirroring options, and subsequently requires the evaluation of many boundary conditions.

After receiving control from the VOS interface, Stripe Control first instructs Image_lnit to perform its initial value computations, and then instructs Image_Update to generate descriptors for the first vertical stripe. Stripe Control then passes control to the Vertical Walker, and waits for the Vertical Walker to indicate that it has completed its actions for the current stripe. If the current stripe is not the last stripe of the source image, Stripe Control instructs Image_Update to derive a new stripe and stripe parameters, and passes control again to the Vertical Walker. When the Vertical Walker is done and the current stripe is the last stripe, control is passed back to the VOS interface.

Vertical Walker and Cache Control

The Vertical Walker manages the source data cache, maintains knowledge of destination line numbers and their source-relative vertical positions, and thereby indirectly controls the vertical data multiplexing and filtering operations of the computational pipeline. After it has received a start command from Stripe Control, the Vertical Walker fills the cache with the first source lines needed by the pipeline, calculates the destination address of the first output pixel to be produced and then starts the Horizontal Walker.

The Vertical Walker performs look-ahead calculations to fetch new source lines into the cache as space in the cache becomes available. When the Horizontal Walker indicates that it has completed processing a line of destination pixels, the Vertical Walker determines if the next set of required source lines is in the cache and restarts the Horizontal Walker with parameters for the next destination line. If all of the required data has not been placed into the cache, the Horizontal Walker is delayed until the source data arrives. The completion of the Horizontal Walker may or may not free space in the cache, depending on the vertical scale factor and the current vertical position.

Because the Horizontal Walker operates within the pipeline stall domain, the interface of the Vertical Walker with the Horizontal Walker obeys the pipeline stall protocol. When the Horizontal Walker completes the last line of destination pixels, the Vertical Walker signals Stripe Control that it has completed processing for the current vertical stripe.

The Vertical Walker fills the cache by making read requests to the Memory Read Interface. Requests consist of a memory address, a length in oct words, the cache address to which the memory data should be written, and a request ID. When the Read Interface completes a request by placing the requested source data into the cache, it signals the Vertical Walker and returns the request's ID. The Vertical Walker uses the request IDs to track the status of data in the cache. The Vertical Walker can generate a number of back to back requests as it advances. The Read Interface can stall the Vertical Walker's request generation by indicating that its request FIFO is full.

Horizontal Walker

The Horizontal Walker launches source pixels from the cache and filter coefficients from the filter tables into the OFS computation pipeline. It directly addresses the cache and the filter coefficient memories and controls the source data multiplexors and the filter coefficient multiplexors so that correct data is selected for each destination pixel. Simultaneously, it delivers the memory address of the destination pixel to the pipeline so that when a newly calculated pixel reaches the end of the pipeline, its address also arrives.

The Horizontal Walker controls the pipeline to produce destination pixels in left to right order. All horizontal position information that it maintains is relative to the current source vertical stripe. When the Horizontal Walker has completed processing for the current destination line, it signals the Vertical Walker that it is ready to process another line. At the end of each line, the Horizontal Walker produces a set of final stripe relative positions and destination pixel numbers, which are used by Image_Update at the end of the processing of a stripe to derive the next vertical stripe.

The Horizontal Walker maintains look-ahead information so that it can signal the Vertical Walker that it is complete early enough to process the last pixel in a line and then the first pixel in the next line without losing a clock cycle. This combined with the reuse of cache data and the look-ahead cache control allows the OFS to sustain pixel production rates close to the maximum burst rate. Thus the major factor that affects the sustained pixel production rate is delays in the response of system memory.

The Horizontal Walker is completely within the pipeline stall domain. The pipeline stall protocol is simple: if the pipeline enable is not asserted, all state and all outputs are frozen; changes can only occur when the pipeline enable is asserted.

Source Data Cache

The source data cache consists of four 256 byte cache lines. Each cache line is segmented into eight segments of four words of eight bytes. The segments are named Cr Low, Cr High, Cb Low, Cb High, Ya Low, Ya High, Yb Low and Yb High. Each segment can be independently addressed by the computational pipeline, so that each cache line presents 64 bytes of data to the pipeline data multiplexors in each clock cycle.

The cache architecture is constrained by the data requirements of the pipeline and the access requirements of the memory controller. The pipeline requires parallel access to many different contiguous patterns of source bytes. The segmentation and tiling structure of the cache is designed so that all of the patterns required by the pipeline are contained in an addressable set of 64 bytes. The access patterns depend on the source format, the filter configuration, the horizontal scale factor, and the horizontal position of the current destination pixels.

When AGP memory is read, the memory controller returns requested data as a sequence of oct words (16 bytes). When local memory is read, the memory controller returns requested data as two independent sequences of oct words, one for the lower oct words of a double oct word sequence, and one for the upper oct words. The arrival of data from these two sequences can occur together, or can be skewed in time by a variable number of clock cycles. The tiling structure and write access to the cache is designed so that data from the memory controller can be placed directly into the cache in most cases. The exception is when planar Cb and Cr data is being fetched, where a two word deep 8 byte FIFO is required to avoid write collisions. So that this FIFO does not overflow, the Vertical Walker must alternate requests for Cb and Cr lines with requests for Y lines; this is temporal tiling.

OFS has two tiling structures used in the cache. For packed data sources, oct words are placed into the cache segments in the pattern Cr, Ya, Cb, Yb. The quad word offsets from the first location in Cr Low are within 8 byte cache memory words. For planar data sources, data from Cr, Cb, and Y planes is placed only in the Cr, Cb, and Y cache segments, respecitively. The Cb and Cr segments are not tiled, but the Y segment is tiled similarly to the way the entire cache is tiled for packed data.

Source Data Multiplexing

The Horizontal Walker provides read addresses to the cache, and simultaneously provides all of the select controls to the source data multiplexor, which receives the cache's data outputs. Thus the mux is provided with 256 bytes of data out of which it selects 54 components to present to the filter. The select lines to the mux control both the vertical and horizontal aspects of component selection. For most formats, the mux operates on a byte level granularity, but for RGB 565 and RGB 555 formats it must operate with a bit level granularity. The mux is responsible for promoting 5 and 6 bit component data to 8 bits, for converting excess-128 chroma components to two's complement form, and for creating black pixels for source pixel locations that are out-of-bounds.

The source data mux is a large circuit of about 50,000 gates, but the data paths are wide rather than deep. The delay path from the cache address outputs of the Horizontal Walker through the cache and the mux is less than a clock cycle.

Computational Pipeline

The computational pipeline includes the Horizontal Walker, cache memory read data path, filter coefficient memory read data path, source data multiplexor, coefficient data multiplexor, filter, color matrix block, gamma table read data path, gamma correction block, fixed RGB to YCbCr color converter, and the chroma low pass filter. The operations of the arithmetic parts of the pipeline are discussed in section 0.

The pipeline is about 15 stages deep, and all of it is stalled when its output FIFO is full. The pipeline carries two pixels per stage when the filter is configured as a dual 3×3 processor, and one pixel per stage when the filter is configured as single 4×4 processor. Whenever two pixels are carried by the pipeline, they are always adjacent pixels in a destination line. The pipeline carries both pixel component data and pixel addresses to the output FIFO.

Pipeline Output FIFO and DOW Packer

The pipeline delivers a pixel address and the components of either one or two pixels to an 8 deep FIFO at the end of the pipe. When the FIFO is almost full, it de-asserts the pipeline enable signal to prevent the pipeline from causing the FIFO to overflow.

The DOW Packer (double oct word packer) reads the pipeline output FIFO. The packer maintains one 32 byte (DOW) register, into which it places destination pixel components at their proper byte offsets. When the packer reads a pixel that belongs in a new DOW address, it transfers the contents of the register and its memory address to the Memory Write Interface, and re-initializes the 32 byte register with the components of the new pixel.

The packer stops transferring data to the Memory Write Interface when the Write Interface's FIFO is full. When the last pixel in the destination image is transferred to the Write Interface, the packer signals this to the Write Interface so that it can flush all of the destination image data to memory. The Write Interface informs the VOS interface that image has been processed either when the last pixel has been written into its FIFO, or when the last pixel has been written to memory, depending on the setting of the Flush When Done bit in the OFS attribute list.

While it is apparent that the invention herein disclosed is well calculated to fulfill the objects previously stated, it will be appreciated that numerous modifications and embodiements may be devised by those skilled in the art, and it is intended that the appended claims cover all such modifications and embodiments as fall within the true spirit and scope of the present invention.

What is claimed is:

1. Video processing engine for processing images for display in a computer graphics system having a main memory, a local memory and a video display, the engine comprising:
a video signal processor decoupled from the video display of the computer graphics system, the video signal processor having main memory-to-local memory operation means.

2. The video processing engine of claim 1 wherein the video signal processor comprises means for writing processed images in a primary graphics buffer for displaying multiple video streams at the same time.

3. The video processing engine of claim 2 wherein the video signal processor comprises an antialiasing filter means for processing 2D and 3D images before being written to the primary graphics buffer.

4. The video processing engine of claim 1 wherein the video signal processor comprises a stretch-blitter means for expanding or contracting graphics images.

5. The video processing engine of claim 1 wherein the video signal processor comprises a dual pipeline means for processing one or more arrays of pixels per clock cycle.

6. The video processing engine of claim 1 wherein the video signal processor comprises a filter core having an upsampling means and a downsampling means for upsampling and downsampling images simultaneously on different color components.

7. The video processing engine of claim 1 further including a video overlay system coupled to the video display, the video overlay system having a horizontal upsampling filter.

8. The video processing engine of claim 1 further including a synchronization means for temporal synchronization between input video sources, the video signal processor, the video display and the video overlay system.

9. The video processing engine of claim 1 wherein the memory-to-memory operation means comprises means for reading video or graphics source images that reside in local memory or in main memory and writes processed images to local memory.
